(19) United States
(12) Patent Application Publication
(10) Pub. No.: US 2018/0364160 A1
(43) Pub. Date: Dec. 20, 2018

(54) SYSTEM AND METHOD FOR OPTICAL MEASUREMENT ON A TRANSPARENT SHEET

(71) Applicant: DSM IP Assets B.V., Heerlen (NL)

(72) Inventors: Gerardus ABEN, Echt (NL); Wolfgang THEISS, Echt (NL)

(21) Appl. No.: 16/060,550

(22) PCT Filed: Dec. 12, 2016
(86) PCT No.: PCT/EP2016/080685

§ 371 Date: Jun. 8, 2018

(30) Foreign Application Priority Data
Dec. 11, 2015 (EP) 15199656.8

(51) Int. Cl. G01N 21/47; G01J 3/02; G01N 21/59; G01N 21/84; G01N 21/86; G01N 21/896

(52) U.S. Cl. CPC G01N 21/474; G01J 3/0254; G01N 21/59; G01J 2001/0481; G01N 21/86; G01N 21/896; G01N 21/8422

(57) ABSTRACT

The invention relates to a system for measuring light transmission and/or light reflection properties of a transparent sample sheet, the system comprising a detection assembly and a control unit, wherein the detection assembly comprises an integrating sphere having a sample port, an illumination port, a detection port, an internal light source positioned at the illumination port, and a photodetector coupled to a spectrometer and positioned at the detection port; means to detect radiation coming either directly from the sample port or from the wall of the integrating sphere; an external light source axially aligned with the sample port; means to illuminate with the internal light source or with the external light source; a reference standard, and means to position it at and from the sample port. This system is relatively compact, and can advantageously be used at existing sheet production lines for process and quality control. The invention also relates to a method for measuring light transmission and/or light reflection properties of a transparent sample sheet that applies said system; and to processes of making a sheet, especially an AR-coated glass sheet, comprising said method.

### FIELD

The invention relates to an optical measurement system, more specifically to a system for measuring light transmission and/or light reflection properties of a transparent sample sheet. The invention also relates to a method for measuring light transmission and/or light reflection properties of a transparent sample sheet using such system, and to a process of making a coated transparent sheet comprising such system or method.

### BACKGROUND OF THE INVENTION

Automated measurement of optical properties of a transparent sheet material in-line with a production process may be desired for example as a processing and product quality control step or to optimize process settings. An example is manufacturing of glass sheets that can be used for example as cover plates of photo-voltaic solar panels, also called solar cover glass. For such application transmission of electromagnetic radiation from the sun through the glass sheet to the active cells should be as high as possible, and reflection of radiation from the surface of the sheet should be minimized. Therefore such solar glass is nowadays generally provided with an anti-reflective (AR) coating on at least the outer surface, which coating is typically applied before the glass sheets are tempered in an oven, during which heat treatment also the coating layer is cured. Reduction of reflection of incident light by an AR coating is dependent on various parameters, including properties of the coating like refractive index and thickness of the applied coating layer. Various optical measurement methods have been described that could be applied in-line with a process of making sheets having an optical coating, like AR-coated solar cover glass. Typically such methods apply optical devices that comprise an integrating sphere, in order to be able to measure both specular and diffuse light reflected from and/or transmitted through—often textured—glass sheets. An integrating sphere (also called an Ulbricht sphere) is known to a skilled person as an optical component having a hollow spherical cavity with its interior surface covered with a matt white multiply diffusely reflective coating, such as barium sulphate, and provided with openings as entrance and exit ports. A relevant property of an integrating sphere is a uniform scattering or diffusing effect. Light incident on any point of the inner surface is, by multiple scattering reflections, distributed equally to all other points, thus enabling measurement independent of direction or scattering of the incoming light at any place within the sphere. An integrating sphere is typically used with a light source and a photodetector and spectrometer for optical power measurement, for example in the wavelength range of visible light.

In U.S. Pat. No. 4,120,582 an apparatus for measuring light reflection and transmission of a sample sheet, like a mirror, is described, which apparatus comprises first and second integrating spheres each having a sample port, the spheres and ports being aligned with one another along an axis, two photodetectors for measuring reflected and transmitted light in first and second sphere respectively, a light source from which a beam of light enters the first sphere and passes via the sample ports into the second sphere, and means for moving the spheres relative to each other to clamp a sample between them at the sample ports. With this apparatus total transmittance and total reflectance of a sample sheet can be measured simultaneously, but requires calibration with standards of low and high reflectivity. Use of this apparatus and method for in-line measurements on moving sheets was not described or envisaged.

US2002/0001078A1 discloses an optical measuring system for quality control in a continuous process on a moving sample. The measuring system comprises two measuring heads at opposing sides of the sample for combined measurement of reflection and transmission. A first measuring head comprises an integrating sphere having a sample port, an integrated light source, a light receiver and at least one spectrometer, and a second measuring head comprises a light receiver and a spectrometer. Preferably a measuring head comprises two spectrometers, one for visible light and one for near infrared wavelengths, and further spectrometers are used to compensate for changes in intensity of the light source and systematic errors. It is further indicated that light-conducting fibers are advantageously used as light receiver, and that switching on/off the light source is preferred over use of a mechanical shutter. A data interface is provided at each measuring head for communicating with an external computer. The measuring heads are aligned to each other in a double crosspiece arrangement which is synchronously movable transverse to the moving sample, allowing to make measurements over the entire width of the sample.

In U.S. Pat. No. 7,969,560 B2 an apparatus and a method for in-line measuring of haze and transmittance on a moving sample like an optical film for a display are described, which apparatus includes a light source aligned with a sample port of an integrating sphere, the sphere further having a scatter sensor positioned at a first detector port and a light trap with a transmittance sensor at a second detector port aligned with the light source and sample port, and an analysis circuit. Calibration of the apparatus is done separately off-line.

A device and method for measuring simultaneously total transmission and diffuse transmission of transparent scattering sheet samples, while the sheets are moving for example during a sheet coating step, are described in U.S. Pat. No. 8,259,294 B2. The applied device comprises an integrating sphere having an internal light source, a reference photodetector, a light exit or sample port, and two light traps that can be active or inactive (together forming a diffuse light emitter); a reference sample; two photodetectors for total transmission and diffuse transmission measurement respectively, each photodetector aligned via the sample port with one of the light traps; and means to jointly move the photodetectors and the integrating sphere relative to and at opposite sides of the sheet sample. The device can be calibrated using the reference sample instead of a sheet sample.

In U.S. Pat. No. 8,830,473 B2 a system and method for measurement of light reflected from a moving sample are disclosed. The system may comprise
an integrating sphere having an illumination port with a light source, a light exit or sample port, at least two detection ports;
a first and a second photodetector;
a reference standard;
optionally a third photodetector arranged opposite the light exit port on the other side of the sample, such that the device may be also used for transmission measurement;
at least one spectrometer for determining wavelength-dependent spectral energy distributions from photodetector signals; and
a control unit.
   In order to enhance accuracy of calibration the system can be switched from measuring operation to calibrating operation by rotating the integrating sphere relative to the reference standard and the sample, which remain at their positions.

U.S. Pat. No. 8,970,830 B2 also describes a system and method for measuring reflection and/or transmission properties of a translucent sample, especially in-line measurement of reflectance of both surfaces of surface-coated sheets during production thereof. The system comprises first and second illuminating devices, the first device comprising a first integrating sphere having an illumination port with a light source, a detection port with a direction-sensitive photodetector, a light trap, and a light exit port, and the second device comprising a second integrating sphere having an illumination port with a light source, a detection port with a direction-sensitive photodetector, and a light exit port, wherein the illuminating devices are spatially arranged in fixed axially aligned positions relative to one another such that a sample sheet can be positioned between first and second integrating spheres and photodetectors. The system further comprises means to alternately switch on and off the light sources, and a control unit. Each integrating sphere may further be provided with a reference photodetector for calibration purposes.

Nevertheless, there remains a need in industry for a system that enables measuring optical properties like transmission and reflection of transparent sheets in-line with a production process for e.g. quality inspection and/or process control and optimization in an adequate and cost-effective way.

It is therefore an objective of the present invention to provide such an optical measurement system and method, and processes applying such system and method.

### SUMMARY OF THE INVENTION

A solution to above problem is achieved by providing the system, methods and processes as described herein below and as characterized in the claims.

Accordingly, the present invention provides a system for measuring light transmission and/or light reflection properties of a transparent sample sheet, the system comprising a detection assembly comprising
an integrating sphere having
   a sample port;
   an illumination port;
   a detection port;
   an internal light source positioned at the illumination port;
   a photodetector coupled to a spectrometer and positioned at the detection port; and
   means to detect radiation coming either directly from the sample port or from the wall of the integrating sphere or both directly from the sample port and from the wall of the integrating sphere;
an external light source axially or a transmittance detector aligned with the sample port;
means to illuminate either with the internal light source or with the external light source (if present) or with no light source;
a reference standard, and means to position it at and from the sample port; and
a control unit.

In a first embodiment containing only one photodetector and spectrometer, the optical measurement system according to the invention comprises a relatively compact detection assembly and can be used for determining transmission and/or reflection properties with only one photodetector and spectrometer; which reduces costs and enables mounting the detection assembly on a frame and using it at an existing production line for making e.g. glass sheets. In a second embodiment containing separate photodetectors and spectrometers for measuring the radiation reflected from the wall, radiation transmitted through the sample from the integrating sphere and radiation reflected from the sample, the optical measurement system according to the invention allows for extremely fast measurement and very low uncertainly of the measurement. The optical measurement systems thus allows to determine transmission and/or reflection properties on transparent samples, also in-line or in-process with a production process of for example sheets while they are being transported, for e.g. quality inspection, process control, and optimization of the sheet production process and of properties of sheets made. The invention also relates to a method for measuring light transmission and/or light reflection properties of a transparent sample sheet using such system, and to a process of making a coated transparent sheet (like AR-coated solar cover glass) applying such optical measurement system or method either off- or in-line.

The terms light, light beam and radiation are used interchangeably in the present document.

The optical measurement system according to the invention comprises a detection assembly comprising an integrating sphere. This integrating sphere is dimensioned such that it can measure a relatively large spot or area on the transparent sample to be measured, also depending on the size of a light beam being used for illuminating. An integrating sphere having a large diameter, and thus also a large internal surface area, relative to its sample opening or detection port generally enhances measurement accuracy. The integrating sphere therefore preferably has a diameter of at least about 100 mm. Too large a diameter may become unpractical and may result in a detection assembly that is more difficult to integrate with a sheet production process. Thus the integrating sphere preferably has a diameter of at most about 500, 400, 300 or 250 mm, more preferably of about 100-250 mm, like about 180 mm.

The integrating sphere has a sample port, which is a generally circular opening in the shell or wall of the sphere and preferably has a diameter of at least about 20, 30, or 40 mm and at most about 80, 70, or 60 mm, and more preferably of about 50 mm. Such sample port dimensioning, which is somewhat larger than the beam width of incident light from an external source, makes it possible to measure light transmitted through a sample as a relatively wide angle bundle, resulting e.g. from scattering induced by the sample. Particularly, it was found that for integrating spheres with a diameter of at least 160 mm and a sample port opening with a diameter of at least 40 mm, it was possible to measure transmittance and reflectance for typical samples with a surface roughness (defined as maximum distance between highest and lowest point) of up to 0.5 mm with excellent precision sufficiently for what is required for measurement of cover glasses for solar PV modules. For applications related to solar modules, the combination of a diameter of the integrating sphere of 160 mm to 300 and a diameter of the sample port opening of 40 mm to 60 mm was found to be highly advantageous in that it can measure light transmittance and/or light reflectance of transparent sample sheet with a surface roughness from smooth glass sheet (like Pilkington Optiwhite) to S side of SM glass and even on the textured surface of light trapping films and structured glass. A further advantage of the system of the invention is that it can measure optical properties on transparent samples that have smooth surface and show little light scattering, as well as of samples with a textured surface or some translucency resulting a scattering of light, that is in a diffuse wide-angle light bundle.

At the outside of the integrating sphere, a seal may be placed around the sample port. Such seal is preferably made from a flexible, for example elastomeric material and may serve to more or less close the gap between sample port opening and surface of either reference standard or sample sheet placed close to the sample port, this way reducing the amount of light from other sources that can enter the integrating sphere and may influence quality of measurements. The seal is optional and particularly an advantage for the embodiment not having a dedicated wall detector. In this embodiment, the wall signal is not measured at the same immediate time as the reflectance and/or the transmittance signal. Any change in the wall signal (for example if more or less light enters the sample port) may lead to an error. In the preferred embodiment, the system comprises a dedicated wall detector so the wall signal and the reflectance and/or transmittance signals can be measured at the same time, so variation in light inside the integrating sphere (for example by a change in degree of coverage of the sample port) will not influence the computation of the transmittance and reflectance.

An internal light source is positioned at an illumination port of the integrating sphere that forms part of the system of the present invention, which illumination port preferably has a diameter of at least 10, 20, 30 mm and at most 70, 60 or 50 mm, and more preferably of about 40 mm. The internal light can be positioned outside the sphere at the illumination port, but can also be placed in the port or even within the sphere depending on its size. Different light sources can be used as internal light source, and similarly for the external light source (see later) as are known to a skilled person. Preferably, the light source, and the power supply unit used with it, produce a very stable signal during operation to result in reproducible high-quality measurements. The illumination port and internal light source can be placed at different positions of the sphere, such that the emitted light bundle is not directed to, that is reaching with a direct or linear pathway, the photodetector or the sample port; but directed to the internal wall surface to result in diffusely scattered light from the surface of the integrating sphere. Effectively, the surface of the integrating sphere can be considered the light source that illuminates the sample port when the internal light source is used. The detection assembly further comprises means to alternately illuminate the sample port, or a sample or reference positioned at this port, either with the internal light source or with the external light source (if present) or with no light source. In an embodiment of the invention, such alternate illuminating is done by switching the respective light sources on and off. In a preferred embodiment the light sources are operated continuously, as this was found to result in better stability of their signals over time, and said means comprise a mechanical shutter provided with each of the internal light source and the external light source (if present), which shutters can effectively block the light from leaving a light source and from entering the integrating sphere and illuminating the sample port. This way the system can measure transmission and reflection properties of a sample with improved accuracy and reproducibility.

A photodetector coupled to a spectrometer is positioned at, or near or in connection with, a detection port of the integrating sphere, which detection port preferably has a diameter of at least 10, 20, 30 mm and at most 70, 60 or 50 mm, and more preferably of about 40 mm. The photodetector and spectrometer of the integrating sphere are coupled such that they actually form a single part together with the other components of the integrating sphere, such that it can be attached to a frame and be moved as a single unit without the different components moving relative to each other. Photodetector and spectrometer together are herein also referred to as photodetector. The coupling between photodetector and spectrometer may use optical fibers, but preferably with a short pathway and without said fibers being moved or bent relative to the photodetector or spectrometer during operation and upon moving the integrating sphere such as on a frame arm, because moving or bending optical fibers may have a negative effect on the spectra obtained and quality of measurement. In general, the present system contains therefore preferably as few as possible optical fibers, and more preferably the system is substantially free from optical fibers. The spectrometer, also called spectrophotometer, can determine wavelength-dependent spectral energy distributions from the photodetector signals; typically a spectrum is recorded in the visible light range, for example in the wavelength range of about 350-1000 nm. Preferably the integrating sphere of the detection assembly and the system contains only one photodetector and one spectrometer in view of reduced complexity and bulkiness of the detection assembly, as well as lower costs. The photodetector/spectrometer used in the optical measurement system, as well as the light sources are selected such that spectra can be obtained with high accuracy and reproducibility, typically with an average error, or average difference between at least 10 recorded spectra with same light source and sample, of less than about 0.5%, preferably less than 0.4, 0.3, 0.2 or 0.1%.

The integrating sphere further comprises means to detect radiation coming either directly from the sample port or from the wall of the integrating sphere with the photodetector or both directly from the sample port and from the wall of the integrating sphere. Generally, a photodetector is direction sensitive, meaning that if the detector is axially aligned with for example the center of the sample port it will predominantly receive and detect the radiation coming from said port, or from a sample or reference plate positioned at the sample port. When the detector is directed to a part of the inner wall surface of the integrating sphere it will detect the radiation for the wall, which is uniformly distributed throughout the sphere, regardless of the origin. Detecting radiation coming either from the sample port or from the wall of the integrating sphere may for example be done by switching the detector between two positions; that is between a position directed to and aligned with the sample port and a position directed to a part of the sphere's wall surface. Alternatively, radiation coming from the sample port may be prevented to directly reach the detector, for example by blocking the direct pathway with a movable baffle, which baffle is preferably provided with the same coating as the inner wall of the integrating sphere, and thus forms integral part of the reflecting inner surface of the sphere. The detector then measures the radiation reflected by the wall and baffle. In a preferred embodiment, the integrating sphere comprises a movable baffle as means to detect radiation coming either directly from the sample port or from the wall of the integrating sphere with one photodetector, wherein said movable baffle can be switched between a position wherein it blocks radiation coming from the sample port from directly reaching the detector, and a position wherein radiation coming from the sample port can directly reach the photodetector. In a further alternative, the means to detect radiation coming either directly from the sample port or from the wall or both is a means to detect radiation coming both directly from the sample port and from the wall of the integrating sphere, and the means comprises two separate photodetectors in the integrating sphere, and optionally two spectrometers, for receiving and detecting the radiation coming directly from the sample port and reflected from the wall of the integrating sphere, respectively. This embodiment allows for simultaneously measurement of transmittance and reflectance, which is particularly advantageous when the sample is moving during measurement.

To enhance the direction sensitivity of the photodetectors, it was found to be advantageous to provide the photodetectors with a collimator. Hence in one embodiment of the invention, each photodetector is provided with a collimator. Furthermore, it was found to be highly advantageous to provide each photodetector with a movable shutter capable of preventing radiation from the integrating sphere from reaching the photodetector. Such a shutter allow for fast measurement of the dark signal without influencing the conditions of the integrating sphere that would occur if the light source is covered by a mechanical shutter as covering the light source would mean a change in temperature of the integrating sphere. Also, arranging the movable shutter at the photodetector particularly at the collimator means that this is where the diameter of the light is smallest and hence a smaller area needs to be covered by the movable shutter of the photodetector leading to faster closing time. All in all, this leads to improved stability and precision of the system.

In one embodiment, the detection assembly further comprises an external light source, which is oriented in axial alignment with the sample port of the integrating sphere; and can be positioned such that its light beam can enter the integrating sphere via the sample port. This external light source is preferably mounted on a second arm of a frame, a first arm of such frame carrying the integrating sphere, and at such distance from said sample port that the light beam of the external light source can pass through a sample sheet that is placed or transported between the arms carrying the external light source and the sample port, respectively. In order to be able to measure a certain surface area of a sample sheet, the light beam has a certain minimum diameter, of for example at least 10, 15, 20, 30 or 40 mm, but preferably smaller than the diameter of the sample port, such as preferably at least 5 or 10 mm smaller, and preferably the diameter is at most about 70, 60 or 50 mm. Preferably the light beam has a diameter of about 40 mm in case of a sample port of about 50 mm. Different light sources can be used as external light source, similarly as for the internal light source; and as are known to a skilled person. Preferably both light sources, and their power supply units are of the same types and produce a very stable signal during operation to result in reproducible high-quality measurements. It is preferred in this respect that during measurement operation both light sources are operated continuously, and that the detection assembly further comprises means to alternately illuminate with either the internal light source or the external light source. Preferably such means comprise mechanical shutters or diaphragms provided with each of the internal and external light source, which shutters can effectively block the light from leaving the light source and/or to not enter the integrating sphere when the shutter is in closed position; this way allowing the system to illuminate with only one light source at a time and to measure transmission and/or reflection properties of a sample. In case the external light source is not moved synchronously with the integrating sphere relative to the sheet sample, see later, the shutter of the internal light source can remain in open position for semi-continuous reflection measurements.

In another embodiment, the system further comprises a transmittance detector, which is oriented in axial alignment with the sample port of the integrating sphere; and can be positioned such that it measures light from the integrating sphere via the sample port. The transmittance detector is preferably a photodetector coupled to a spectrometer. This transmittance detector is preferably mounted on a second arm of a frame, a first arm of such frame carrying the integrating sphere, and at such distance from said sample port that the light from the integrating sphere can pass through a sample sheet that is placed or transported between the arms carrying the transmittance detector and the sample port, respectively. The use of a transmittance detector instead of the external light source allows for simultaneously measurement of transmittance and reflectance. Furthermore, it enhances thermal and mechanical stability of the system in that the internal light source does not need to be covered during the measurement of the transmittance. This embodiment has no external light source.

In one embodiment, the system comprises the means to detect radiation coming both directly from the sample port and from the wall of the integrating sphere, wherein the means comprises one photodetectors and spectrometers for measuring radiation from the wall of the integrating sphere, and one photodetectors and spectrometers for measuring radiation from the integrating sphere reflected from the sample port. This system comprises the transmittance detector axially aligned with the sample port and no external light source, and the photodetectors are capable of—during use—to measure radiation from the wall, radiation reflected from the sample port and radiation transmitted via the sample port at the same time.

The detection assembly further comprises a reference standard, and means to position this standard at and from the sample port. The reference standard can be a rectangular or rounded plate and preferably having a size sufficient to cover and close the sample port, and having well-defined transmittance and reflectance values, as have been determined separately and independently with other instruments than present system. The type of reference standard may be selected based on the sample sheet to be tested; for example having similar transmittance. Alternatively one or more reference standards having different optical properties may be applied, for example of relatively high and low transmittance. The skilled person will be able to select a reference standard suited for a given measurement situation. Positioning the reference standard at and from the sample port may be done with mechanical means, for example using a movable sample holder that is attached to the integrating sphere, which sample holder can contain at least one reference standard. In one embodiment, the sample holder contains two or more different reference standards having different transmittance and/or reflectance values and the means to position the reference standard can position a selected reference standard at the sample port or all reference standards from the sample port. Alternatively, a sample holder may be attached to a frame, which also carries the integrating sphere and external light source. In such case the reference standard can remain at a fixed position to allow reference standard measurements by moving the integrating sphere into a suitable position to cover the sample port with the reference standard, or the reference standard, optionally with a sample holder, may be movable to allow measurements at multiple positions along the frame. If the reference standard does is not sufficiently large to cover the sample port, it is preferred that the system has a dedicated wall detector in addition to one or more detectors for measuring the reflectance and/or transmittance signals, so the wall signal and reflectance and/or transmittance signals can be measured at the same time. In this way, the effect of variation in light inside the integrating sphere resulting from a not full covering of the sample port can be removed when the computation of the transmittance and reflectance. In a highly preferred embodiment, the reference sample is a silicon wafer. This has the advantage that reflectance of a silicon wafer is well defined and does not need separate external calibration.

The system for measuring light transmission and/or light reflection properties of a transparent sample sheet further comprises a control unit, which unit is configured to control operating of the detection assembly and its various components and means, and to acquire, store and process measurement information from the photodetector and spectrometer. The control unit is connected with the various other components of the system, and may further comprises for example an external computer and/or one or more external displays or keyboards. Connections may be made by wires or lines, or may be wire-less. It is possible to accommodate the external devices and optionally the control unit in a control room remote from the measurement location; for example with other process control equipment in case of applying the system for in-process production control measurements.

The components of the detection assembly, specifically the integrating sphere and external light source, may be shielded by a casing or housing surrounding the components. Such casings serve to electrically, thermally, optically and/or mechanically shield the components and protect them from dirt or dust, and have only openings to allow the optical measurements to be performed and for connecting the components of the system with each other. This is especially advantageous during use of the system to perform measurements in-line or in-process in an production environment.

The system for measuring light transmission and/or light reflection properties may further comprise a frame on which components like those of the detection assembly are mounted. Preferably such frame comprises at least two arms, between which arms the sample to be measured can be positioned or transported in order to be measured. In order to maintain the relative alignment of components, the arms are preferably parallel to each other. Preferably, a first arm of such frame carries the integrating sphere, and a second arm of a frame carries the external light source. Generally a sample sheet is in substantially horizontal position when being measured and/or transported, and the integrating sphere can be positioned either above or below the sheet, depending on the available space, with the external light source at the opposite side of the sheet. The arms of the frame are arranged opposite each other such that the external light source, or more specifically its light beam, is or can be aligned with the sample port of the integrating sphere, and at such distance from the sample port that a sample sheet can be placed or be transported between the arms in close proximity with the sample port or optionally its seal, without actual contact. Preferably, the arms are oriented perpendicular to the length or transport direction of the sheet to be measured, such that measurements can be done at multiple places across the width of the sheet. In a preferred embodiment, the integrating sphere, and optionally the external light source are movably mounted to the arms of the frame, for example with a gliding mechanism like a rail, such that their relative alignment can be maintained.

In an embodiment the system according to the invention therefore further comprises means to, step-wise or continuously, move the detection assembly relative to a sample sheet to be measured, also referred to as a scanning device or a scanning traverse device. In this embodiment, the system with a transmittance detector and no external light source is highly preferable since this system allows for simultaneous measurement of transmittance and reflectance. In another embodiment the system according to the invention further comprises means to, step-wise or continuously, synchronously move the external light source and integrating sphere, while maintaining their mutual alignment and alignment relative to a sample sheet placed between the sphere and the external light source. Preferably, such (step-wise) movement can take place across the width of the sheet sample, to enable a number of measurements or a line of measurements traversing the width of the sheet sample. In case the sample sheet is simultaneously being transported, for example when applying the system for in-process measurements, such measurements made with external light source/transmittance detector and/or integrating sphere moving transverse (perpendicular) to the transport direction will result in measurements along a virtual line that crosses the sample sheet at an angle, for example diagonally. When the external light source/transmittance detector and/or integrating sphere move up and down across the width of the sheet, the measurements can be made along a virtual zig-zag pattern covering the sheet. The actual path or pattern formed is of course dependent on the speed of moving sphere and light source, and the transport speed of the sheet. Said moving of the light source and/or sphere is controlled by the control unit.

In a further embodiment of the system of the invention a sample holder for a reference plate is also mounted on the frame, either on the arm also carrying the integrating sphere, or to a further arm, and can be in a fixed position or optionally be moved to and from the sample port of the integrating sphere.

The optical measurement system according to the invention, or more specifically the detection assembly thereof, is based on the principle of an integrating sphere that after a first reflection of light radiating on any point of the sphere inner wall the radiation is evenly distributed within the whole sphere, to result in a photodetector signal independent of the original direction of the incident light. The ratio of the detector signal and the intensity of the light incident on the wall is called gain factor G of the integrating sphere. The gain factor depends on various geometrical dimensions and material properties of the sphere, but in particular also on the optical properties of the sample port, which port has—either with or without a sample covering the opening—deviating properties from the rest of the sphere inner surface. In fact, gain factor G will be different in case the sample port of the sphere is without any sample (G_{empty}), with a reference standard (G_{reference}), or with a sample to be measured (Gₛₐₘₚₗₑ). In order to determine the transmittance T of a sample to be measured with the system of the invention 4 different spectra are to be recorded, and similarly from 4 recorded spectra the reflectance R of a sample can be derived; as will be further elucidated below.

Determining the transmittance T of a sample with the system of the invention using an external light source includes recording 2 spectra using the external light source and 2 spectra using the internal light source:
spectrum 1: axial detector signal I₁ measured with the external light source and without any sample or reference at the sample port; wherein I₁=Iₑₓₜₑᵣₙₐₗ*G_{empty}*S_{axial detector};
spectrum 2: axial detector signal 12 measured with the external light source and with the sample to be measured at the sample port; wherein I₂=Iₑₓₜₑᵣₙₐₗ*Gₛₐₘₚₗₑ*T*S_{axial detector};
spectrum 3: wall detector signal I₃ measured with the internal light source and without sample; wherein I₃=Iᵢₙₜₑᵣₙₐₗ*G_{empty}*S_{wall detector}; and
spectrum 4: wall detector signal I₄ measured with the internal light source and with the sample; wherein I₄=Iᵢₙₜₑᵣₙₐₗ*Gₛₐₘₚₗₑ*S_{wall detector}.
   Here, axial detector may be a dedicated axial photodetector arranged axially to the sample opening or a general photodetector arranged in this position. The wall detector may be a dedicated wall photodetector arranged to measure the light reflected by the inner wall of the integrating sphere or a general photodetector arranged to do so. Transmittance of the sample can thus be calculated form these measurements as

T=(I₂/I₁)*(I₃/I₄)

Determining the transmittance T of a sample with the system of the invention using a transmittance detector also 4 spectra are to be recorded, but using only the internal light source for illuminating:
spectrum 1: transmittance detector signal I₁ measured with the internal light source and without any sample or reference at the sample port; wherein I₁=Iᵢₙₜₑᵣₙₐₗ*G_{empty}*S_{transmittance detector};
spectrum 2: transmittance detector signal I₂ measured with the internal light source and with the sample to be measured at the sample port; wherein I₂=Iᵢₙₜₑᵣₙₐₗ*Gₛₐₘₚₗₑ*T*S_{transmittance detector},
spectrum 3: wall detector signal I₃ measured with the internal light source and without sample; wherein I₃=Iᵢₙₜₑᵣₙₐₗ*G_{empty}*S_{wall detector}; and
spectrum 4: wall detector signal I₄ measured with the internal light source and with the sample; wherein I₄=Iᵢₙₜₑᵣₙₐₗ*Gₛₐₘₚₗₑ*S_{wall detector}.
   Transmittance of the sample can thus be calculated form these measurements as

T=(I₂/I₁)*(I₃/I₄)

For determining the reflectance R of a sample also 4 spectra are to be recorded, but using only the internal light source for illuminating:
spectrum 5: reflectance detector signal I₅ measuring light as directly reflected from the reference standard having known reflectance value R_{reference} positioned at the sample port; wherein I₅=Iᵢₙₜₑᵣₙₐₗ*R_{reference}*G_{reference}*S_{reflectance spectrometer}
spectrum 6: reflectance detector signal I₆ of the light directly reflected from the sample positioned at the sample port; wherein I₆=Iᵢₙₜₑᵣₙₐₗ*R*Gₛₐₘₚₗₑ*S_{reflectance spectrometer};
spectrum 7: wall detector signal I₇ of the light reflected from the wall of the sphere, with the reference standard at the sample port; wherein I₇=Iᵢₙₜₑᵣₙₐₗ*R_{wall}*G_{reference}*S_{wall detector}; and
spectrum 8: wall detector signal I₈ of the light reflected from the wall of the sphere, with the sample at the sample port; wherein I₈=Iᵢₙₜₑᵣₙₐₗ*R_{wall}*Gₛₐₘₚₗₑ*S_{wall detector}.
   Here, reflectance detector may be a dedicated reflectance photodetector arranged to measure light reflected by the sample or reference at the sample opening or a general photodetector arranged to do so. The reflectance R of the sample can now be calculated as R=(I₆/I₅)*(I₇/I₈)R_{reference}.

The invention also relates to a method for measuring light transmission properties of a transparent sample sheet using the system according to the invention, the method comprising the steps of a1) recording a spectrum using the external light source and without any sample at the sample port, a2) recording a spectrum using the external light source and with the sample sheet positioned at the sample port, a3) recording a spectrum using the internal light source and without any sample at the sample port, a4) recording a spectrum using the internal light source and with the sample sheet positioned at the sample port, and c) computing transmittance T from these spectra; based on the principle as described above.

The invention also relates to a method for measuring light reflection properties of a transparent sample sheet using the system according to the invention, the method comprising the steps of b1) recording a spectrum of radiation directly reflected from the sample port using the internal light source and with a reference standard at the sample port, b2) recording a spectrum of radiation directly reflected from the sample port using the internal light source and with the sample sheet positioned at the sample port, b3) recording a spectrum of radiation reflected from the wall using the internal light source and without a sample at the sample port, b4) recording a spectrum of radiation reflected from the wall using the internal light source and with the sample sheet positioned at the sample port, and c) computing reflectance R from these spectra; as described above.

The invention also relates to a method for measuring light transmission properties of a transparent sample sheet using the system having a transmittance detector and no external light source according to the invention; the method comprising the steps of a1) recording a spectrum using the transmittance detector and the internal light source and without any sample at the sample port, a2) recording a spectrum using the transmittance detector and the internal light source and with the sample sheet positioned at the sample port, a3) recording a spectrum using the photodetector positioned at the detection port and the internal light source and without any sample at the sample port, and a4) recording a spectrum using the photodetector positioned at the detection port and the internal light source and with the sample sheet positioned at the sample port, and c) computing transmittance T from these spectra; as described above.

The invention also relates to a method for measuring light transmission and reflection properties of a transparent sample sheet using the system according to the invention, the method comprising steps a1)-a4) as defined above, steps b1)-b4) as defined above, and a step c) of computing transmittance T and reflectance R from these spectra; as further described in the above.

Performing the different steps a1)-a4) and/or b1)-b4) in the methods of the invention need not be done in the indicated order, also other sequences can be used. If multiple measurements are to be done at different spots or along a line on one or more sample sheets, steps of recording spectra without any sample or with a reference standard need not be repeated with every recording of a spectrum on the sample sheet. In such case, more time is available for measurements on the sample sheet, especially if the method is applied in-line with a continuous or semi-continuous process. Particularly, it is preferred that the step b1) is carried out with a frequency of less than once every 10 sample sheets, preferably with a frequency of less than once every 30 sample sheets, and more preferably with a frequency of less than once 100 sample sheets. Also, it is preferred that steps a1) and a3) are carried out between sample sheet and the recorded spectra in steps a1) and a3) are used for computing transmittance T and/or reflectance R for multiple measurements of a2), a4) and/or b2). For the system having a transmittance detector and no external light source according to the invention, it is highly preferred that the steps a2), a4) and b2) are carried out at the same time, preferably the measurement of steps a2), a4) and b2) is carried out at least 5 times for each sample sheet, more preferably the measurement are carried out at different positions of each sample sheet.

In one embodiment of the invention, each photodetector of the system is provided with a collimator and a movable shutter for preventing radiation from the integrating sphere from reaching the photodetector the shutter is movable between an open position (where radiation may enter the photodetector from the integrating sphere) and a closed position (where the shutter blocks radiation from the integrating sphere). In a preferred embodiment of operating this equipment, the method comprises the step of measuring a dark signal from the photodetector with the shutter in the closed position and subtracting the dark signal when computing transmittance T and/or reflectance R. Frequent measuring of the dark signal is advantageous as it allows for taking into account even slight drifting of the photodetector signal. Therefore, it is preferred that the dark signal is measured at least one time for each photodetector for each sample sheet.

The reflectance detector is preferably arranged pointing towards the sample opening and at an angle from axial alignment with the sample port. This angle may for example be 10 to 25° and preferably about 15°. Due to the direction sensitivity of the detector (preferably enhanced by use of a collimator) this arrangement in reality means that radiation from an area of the integrating sphere arranged at the same angle but opposite to axial orientation acts as light source for the reflectance measurement. Hence, to enhance a good quality reflectance measurement, it is advantageous that no openings are arranged near this area of the integrating sphere.

It is also possible to record such spectra before and/or after measuring a series of sample sheets, and to compute T and R values for a given sample sheet at a later stage or to use stored data for direct computing.

In the methods described above both transmission and/or reflection properties can be measured at one fixed a position of the sample sheet, while the sheet is at rest at the sample port, i.e. as a single measurement; but also at multiple positions of the sample sheet to compute multiple values or averaged values. The external light source and integrating sphere can be moved step-wise from one measuring spot to a next measuring spot, but can also be moved continuously across the sample sheet or part thereof.

In the methods of the invention to measure transmission and/or reflection properties, the sample sheet can also be transported and be measured while passing the sample port, in addition to being measured while at rest at the sample port. Transported of the sample sheet may be continuously, or step-wise or intermittently. Such methods are advantageously used in-line or in-process with a production process of for example coated sheets; to generate data for quality control or production certificates, but also to optimize the production process settings and for example layer thickness of a coating being applied. In-line or in-process is herein understood to mean that measurements are performed without interrupting a production process, or otherwise significantly interfering with a production process.

Thickness of a coating layer may for example be established by modelling based on the measured transmittance curve. Being able to do this inline is highly advantageous, since it allows for feeding back to the coating process controller together with the optical properties of the coated substrate and hence allow for inline optimizing of both the coating application and the coating curing process. This is particularly advantageous for multi-layered coatings as each step of the multilayer coating process can be analysed inline individually leading to a major improvement in the manufacturing of multilayer coating for example in less waste as well as improved and more consistent properties of the coated substrate.

In a way of performing the method according to the invention transmission properties of a sample sheet are measured at fixed transverse position of the sample sheet, and reflection properties across at least part of the width of the sample sheet while transversely moving the integrating sphere, for example along a frame arm. In such method the sample sheet can be at rest, but can also be continuously transported.

In another way of performing the method according to the invention transmission and reflection properties are measured at multiple positions, by synchronously moving the integrating sphere and external light source transversely relative to the sample sheet transport direction if continuously being transported or while the sample sheet is at rest; while maintaining the alignment of integrating sphere and external light source, and of detection assembly and sample sheet.

The invention further relates to a process of making a transparent sheet, like anti-reflective (AR) coated solar cover glass, which process applies an optical measurement system according to the invention or comprises a method for measuring light transmission and/or reflection properties according to the invention, the system or method including all variations and alternative and preferred features as described herein.

More specifically, the invention relates to a process of making an AR-coated transparent non-continuous sheet comprising steps of
i) applying a liquid AR coating composition to the sheet;
ii) drying and curing the applied coating composition; and
iii) measuring light transmission and/or reflection properties of the coated sheet.
iv) adjusting step i) and/or step ii) based on the results of step iii), to result in a sheet having desired light transmission and/or reflection properties.

Said desired light transmission and/or reflection properties have been predetermined, and typically provide ranges within which measured values for transmittance and/or reflectance should fall.

Preferably, in said processes of the invention the step measuring of optical properties is performed in-line with other steps.

An anti-reflective or light reflection reducing coating is a coating that reduces the reflection of light from the surface of a sheet relative to uncoated sheet; preferably at one or more wavelengths in the visible range, e.g. between 425 and 675 nm.

In a another preferred embodiment of the process according to the invention, the process further comprises a step v) of determining whether the measured coated sheet fulfils certain predetermined quality specifications, like ranges within which measured properties should fall.

With the process of the invention it is also possible to identify individual sheets, as the transmission and/or reflection measurements will be different if there is a sheet at the sample port or if the sample port is open and empty; as will occur if there is a certain distance between successive discontinuous sheets being transported. It is thus possible to provide each sheet being measured with a unique code or identifier, and to link the measurement results to the respective coded sheet. The present process thus allows determining whether each measured coated sheet is according to predetermined specifications or not, and to make (electronic) records containing such measurement results, and optionally other relevant processing information like starting material, production settings, date, time, etc.. The unique identifier, and optionally other data, may be provided to each sheet, for example as a (machine) readable label. The process according to the invention can thus be used for in-process measurements, optimizing of process settings, and for quality control and certification of sheets produced. In one embodiment, the process of making claim 17 further comprising the step of making an AR-coated transparent non-continuous sheet therefore further comprises the steps of
a) applying a unique identifier to the sample sheet or reading a unique identifier of the sample sheet; and
b) create a record of the light transmission and/or reflection properties of the coated sheet together with the unique identifier, and optionally add conditions of step i) and/or step ii) in the record.

It was found that a particularly advantages use of the systems or methods according to the invention is therefore for inline quality assurance in manufacturing of solar modules.

The transparent sample sheet that can be measured with the system and method of the invention, or the transparent sheet that can be made with the process of the invention can be a non-continuous or discontinuous sheet of finite length (also called discrete or individual sheet), or a continuous sheet (also called continuous web or web). The sheet being transparent means within present application that it is at least partly transparent for visible light, meaning an optically translucent sheet is also transparent. Such non-continuous sheet may optionally be rigid; for example a flat panel or plate like a glass sheet. A non-continuous or discrete sheet is typically transported with e.g. rolls or a transporting belt. Typically, sheets are transported and coated in substantially horizontal position with the coating being applied to the top surface of the sheet, although other orientations may be used as well. Preferably the sheet is a flat panel or plate, with thickness significantly smaller than length and width. Such sheet may have some flexibility to allow a certain degree of bending, but typically is non-flexible and rigid (i.e. self-supporting under its own load when a sample is locally supported at spots about 1 m apart). The geometry and size of the sheet is not critical, but preferably the sheet is of a uniform thickness and size. Use of flat rectangular rigid sheets is preferred, with edges that may have various different forms, and may be sharp (e.g. about 90°), rounded, or facetted. The transparent sheet can be made from an organic or inorganic material; the sheet can include inorganic glasses (e.g. borosilicate glass, soda lime glass, glass ceramic, aluminosilicate glass), plastics (e.g. PET, PC, TAC, PMMA, PE, PP, PVC and PS), or composite materials like laminates. Preferably the sheet is a glass, like a low-iron soda-lime glass or a borosilicate glass; preferably a flat glass like float glass, or rolled glass with smooth or patterned surface.

The sheet may be provided with an optical coating, which is understood to be a coating layer on a surface, which coating changes optical properties like reflection or transmission of light of the sheet, and has dry layer thickness below 1 μm; like an anti-reflective coating.

It is preferred that the coating is an AR coating, but the system and the use of the system is not limited to AR coatings. Particularly, the coating may alternatively be a non-porous coating or a multilayer coating with at least one porous layer and optionally one or more non-porous layers.

A liquid AR coating composition typically comprises at least one binder, at least one pore forming agent, and at least one solvent. Suitable compositions comprise binders based on organic and/or inorganic compounds, like those compositions that result in porous inorganic oxide, for example silica, coatings. Such compositions have been described in numerous publications; including EP0597490, U.S. Pat. No. 4,830,879, U.S. Pat. No. 5,858,462, EP1181256, WO2007/093339, WO2008/028640, EP1674891, WO2009/030703, and WO2011/157820. In the process according to the invention a liquid AR coating composition may be used that comprises as binder at least one inorganic oxide precursor, which upon drying and especially curing of the composition will form a film and bind together particles that may be present in the coating, to result in mechanical properties of the AR layer and adhesion to the surface. The inorganic oxide precursor can be an inorganic metal salt or an organo-metallic compound, preferably a metal alkoxide, and combinations thereof. Within the present application silicon (Si) is considered to be a metal. Suitable metals include Si, Al, Ti, Ta, Nb and Zr, and mixtures thereof. Preferred precursors include Si alkoxides like tetramethoxysilane (TMOS), tetraethoxysilane (TEOS), methyltrimethoxysilane, methyltriethoxysilane, titanium tetraisopropoxide, aluminium nitrate, aluminium butoxide, yttrium nitrate and zirconium butoxide. Such compounds can have been pre-reacted or pre-hydrolysed to form oligomeric species, typically in the form of nano-sized particles. More preferably, the at least one precursor comprises TMOS and/or TEOS.

The AR coating composition used in present invention further contains at least one pore forming agent, which helps in generating suitable porosity in the final AR layer to provide a desired refractive index. The coating composition generally contains solvent and organic ligands from organo-metallic precursor compounds, which compounds may already induce some porosity to the inorganic oxide layer upon curing. Preferably the composition comprises additional pore forming agents to enhance and control porosity and pore sizes. Suitable pore forming agents include organic compounds like higher boiling (i.e. less volatile) solvents, surfactants and organic polymers, and inorganic particles having sub-micron particle size, i.e. nano-particles like core-shell nano-particles with a metal oxide shell and an organic core. A pore former can be removed during thermally curing the coating at temperatures above the decomposition temperature of the pore forming agent. A combined treatment of dissolving and degrading/evaporating the compound, like a polymer, may also be applied. Typically, the resulting AR coating layer has a pore size of about 30-150 or 50-125 nm after curing.

Suitable solvents for the AR coating composition are preferably miscible with water or can at least dissolve a certain amount of water. Examples include organic solvents like ketones, esters, ethers, alcohols, and mixtures thereof. Preferably the solvent is an alcohol, more preferably a lower aliphatic alcohol like methanol, ethanol, propanol, or butanol. Ethanol and isopropanol are particularly preferred solvents.

The coating composition can be applied directly to the sheet, but also to another coating layer already present on the sheet; like a barrier layer for alkali ions, or an adhesion promoting layer. The coating composition is preferably applied to the sheet surface for making a (single layer) AR coating in such wet thickness that will result in a thickness after drying and/or curing of about 20 nm or more, preferably the applied cured coating has a layer thickness of at least about 50 or 70 nm and of at most about 200, 180, 160 or 140 nm. In case of a multi-layer coating the skilled person may select different layer thicknesses and/or layers of different compositions and refractive index. For applying the coating composition any suitable method can be used, as known to a skilled person, like roll coating, extrusion coating, spray coating etc. Preferably a roll coating technique like forward- or reversed-roll coating is applied.

In the process according to the invention the step of drying and curing the applied coating composition will comprise drying to evaporate at least part of solvent(s) and other volatile components, and then curing to complete reaction of a binder into for example inorganic oxide(s), and optionally removing residual and non-volatile organic components. Drying preferably takes place under ambient conditions (e.g. 15-30° C.), although elevated temperatures (e.g. up to about 250° C., more preferably up to 100, 50 or 40° C.) may also be used to shorten the total drying time. Drying may be promoted by applying an inert gas flow, or reducing pressure. Specific drying conditions may be determined by a person skilled in the art based on solvent or diluent to be evaporated.

After drying, i.e. after substantially removing volatile components, the applied layer is preferably cured. Curing may be performed using a number of techniques including thermal curing, flash heating, UV curing, electron beam curing, laser induced curing, gamma radiation curing, plasma curing, microwave curing and combinations thereof. Curing conditions are depending on the coating composition and curing mechanism of the binder, and on the type of sheet. The skilled person is able to select proper techniques and conditions. Thermally curing coatings at e.g. temperatures above 120, or above 250° C. is preferred for inorganic oxide precursors as binder. Such conditions are often not possible for a plastic substrate. In such case flash heating may advantageously be applied to minimise exposure of the substrate to high temperature; as is for example described in WO2012037234. After curing the coating, residual organics including organic pore forming agent can be optionally (further) removed by known methods; for example by exposing the coating to a solvent and extracting the organic compound from the coating. Alternatively, an organic compound or polymer can be removed by heating at temperatures above the decomposition temperature of the organic polymer, especially in case of glass sheets. Suitable temperatures are from about 250 to 900° C., preferably above 300, 400, 450, 500, 550 or 600° C., during at least several minutes. Such heating will also promote formation of oxides from inorganic oxide precursors, especially when in the presence of oxygen; resulting in both curing and removing organics by calcination.

In a preferred embodiment, organics are removed from the applied coating composition by heating combined with thermally curing the coating. For example, in case of an inorganic glass sheet curing can be performed at relatively high temperatures; of up to the softening temperature of the glass. Such curing by heating is preferably performed in the presence of air, and is often referred to as firing in e.g. glass industry. If desired, the air may comprise increased amounts of water (steam) to further enhance curing and formation of an inorganic oxide coating. The product obtained by such method is typically a fully inorganic porous coating.

In a further preferred embodiment, such curing step is combined with a glass tempering step; i.e. heating the coated glass sheet to about 600-700° C. during a few minutes, followed by quenching, to result in AR-coated toughened or safety glass sheet.

The AR-coated transparent sheet made with the process according to the invention may be used in many different applications and end-uses, like window glazing, cover glass for solar modules, including thermal and photo-voltaic solar systems, or cover glass for TV screens, monitors, touch-screen displays for mobile phones, tablet pc's or all-in-one pc's, and TV sets.

All references, including publications, patent applications, and patents, as cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode for carrying out the invention as known to the inventors at the time of filing. Variations of preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. While certain optional features are described as embodiments of the invention, the description is meant to encompass and specifically disclose all combinations of these embodiments unless specifically indicated otherwise or physically impossible.

For the purpose of clarity and a concise description features are described herein as part of the same or separate embodiments, however, it will be appreciated that the scope of the invention may include embodiments having combinations of all or some of the features described.

### BRIEF DESCRIPTION OF THE DRAWINGS

FIG. 1 schematically illustrates an example of an optical measurement system according to the invention by a simplified cross-sectional side view representing relevant components of the system, in a position for measuring transmittance and reflectance on a sample sheet.

FIG. 2 schematically illustrates a system as in FIG. 1, but in a position for measuring transmittance and reflectance on a standard reference.

FIG. 3 schematically illustrates an alternative embodiment of the invention that comprises two photodetectors.

FIG. 4 schematically illustrates an alternative embodiment of the invention containing a transmittance detector and no external light source.

In general, the figures as presented herein may not show all parts or components of a system according to the invention, and/or may not represent them to scale. Equivalents parts are indicated by the same numerals in these figures.

### DESCRIPTION OF PREFERRED EMBODIMENTS

The invention will be further illustrated by the following embodiments, without being limited thereto.

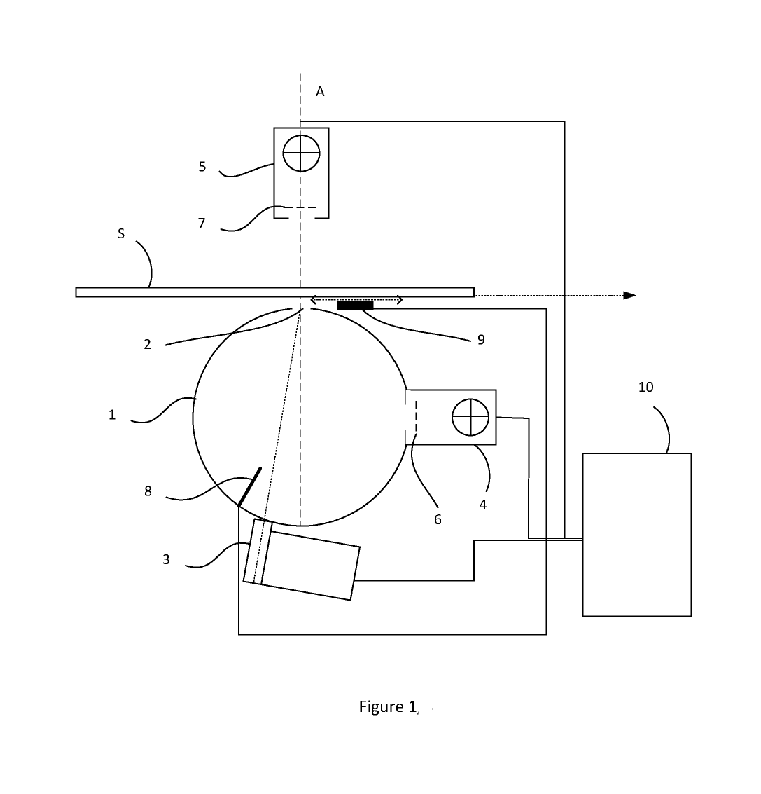

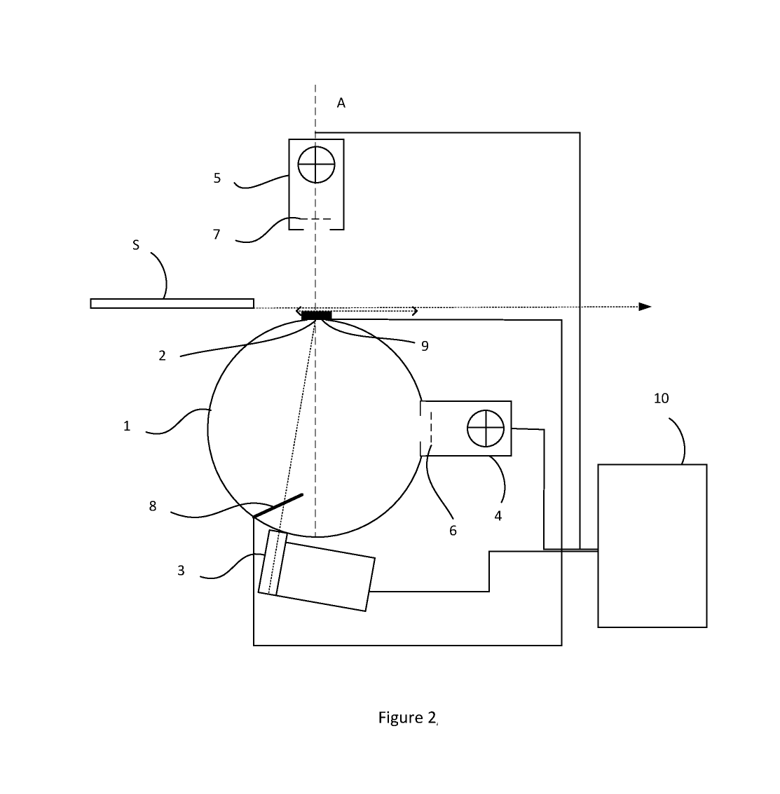

The system for measuring light transmission and/or light reflection properties of a transparent sample sheet as schematically and partly presented in FIG. 1 basically comprises a detection assembly and a control unit 10. The detection assembly comprises various components, which assembly can be mounted on e.g. a frame (not shown). The detection assembly includes an integrating sphere 1 of 180 mm diameter, which spherical hollow body was made using an Ultimaker 3D printer. The inner surface of the sphere and of other parts within the sphere are homogeneously coated with barium sulfate to result in even distribution of incident radiation throughout the sphere. The sphere has three circular openings in its wall, serving as a sample port 2, an illumination port, and a detection port. The sample port 2 has a diameter of 50 mm, such that an incident external light beam of about 40 mm will fully enter the integrating sphere, also passing through a scattering sample situated close to the port. Optionally, a flexible ring (not shown) is placed around the sample port on the outside of the sphere, forming a seal or bridge between sample to be measured and integrating sphere without actually contacting the sample sheet, and minimizing light from other sources entering the sphere. Internal light source 4, is positioned at the illumination port having a diameter of 38 mm. A photodetector coupled to a spectrometer, is positioned at the detection port of diameter 38 mm, such that the detector is directed to the sample port to detect radiation coming from the sample port, which can be empty (without a sample or reference material), or be covered by a sample sheet S or reference standard 9. The photodetector collects radiation, which is then sent to the coupled spectrophotometer to record intensity versus wavelength in the range of 380-1000 nm. The integrating sphere 1 further is provided with a movable baffle 8, as means for switching from detecting radiation coming from the sample port, or from the wall of the integrating sphere by masking out radiation directly from the sample port; see also FIG. 2. For such purpose baffle 8, which is also coated with barium sulfate, can be mechanically moved between two positions. The detection assembly further has an external light source 5, which is axially aligned along axis A with the sample port such that its collimated light beam of diameter 40 mm enters the sample port of the sphere 1. Both internal light source 4 and external light source 5 are provided with mechanical shutters 6 and 7, respectively, enabling illumination with either with the internal light source or with the external light source. This means that both light sources can be kept continuously on, rather than being switched on and off; to result in constant and stable radiation sources. The detection assembly further includes reference standard 9, which can be mechanically positioned at or from the sample port, to enable making quantitative measurements. The detection assembly is mounted on frame, having two arms such that a sample sheet S can be transported with transporting means (not shown) between the integrating sphere and external light source; transport direction being indicated with an arrow in FIG. 1. Both integrating sphere and external light source can be moved along the frame arms transversely relative to the sample sheet transport direction, while maintaining their relative alignment as well as distance and alignment relative to a sample sheet. The distance between sample sheet and integrating sphere is minimized, while securing both will not actually contact. In one way of using the measuring system in a process of the invention, the external light source is kept in a fixed position for transmission measurements along a virtual line path over moving sample sheet S and parallel to its transport direction when aligned with the integrating sphere; whereas the integrating sphere is moved transverse to the transport direction between the side edges of the sample sheet, thus making a virtual diagonal or zig-zag path over moving sample sheet S while making reflection measurements. In another embodiment of the invention, the external light source and the integrating sphere are moved synchronously transverse to the transport direction between the side edges of the sample sheet, thus making a virtual diagonal or zig-zag path over moving sample sheet S while making transmission and/or reflection measurements. The measuring system further comprises a control unit, which is configured to control operating and moving of the detection assembly and its components, and to acquire, store and process measurement information.

FIG. 1 shows the system of the invention during a method of measuring transmission and reflection properties of a glass sheet having an anti-reflective coating on one of its surfaces, while the sheet S passes the sample port 1 and is illuminated by external light source 5 to record detection signal 12 and spectrum 2 of the light transmitted by sheet S. For determining transmittance T of the sheet S three more measurements are needed in accordance with the measurement principle as described in the above:
spectrum 1: detection signal I₁ of external light source 5 with no sample at sample port 2;
spectrum 3: detection signal I₃ of internal light source 4 with no sample at sample port 2;
spectrum 4: detection signal I₄ of internal light source 4 with sample S at sample port 2.
   In order to reduce total measuring time, and to enable more spectra are recorded on the moving sample sheet, spectra 1 and 3 may already have been recorded and stored in the control unit. The transmittance T of sample S is now calculated as T=(I₂/I₁)*(I₃/I₄).
   For determining the reflectance R of sample sheet S similarly 4 spectra are recorded, but using only the internal light source 4:
spectrum 5: detection signal I₅ of internal light source 5 directly reflected from reference standard 9 with known reflectance R_{reference} at sample port 2;
spectrum 6: detection signal I₆ of internal light source 5 directly reflected from sample sheet S at sample port 2;
spectrum 7: detection signal I₇ of internal light source 5 reflected from the wall with reference standard 9 at sample port 2;
spectrum 8: detection signal 1₈ of internal light source 5 reflected from the wall with sample sheet S at sample port 2.
   As for measuring T, spectra 5 and 7 may be recorded at a different time than sample S. The reflectance R of sample S is now calculated as R=(I₆/I₅)*(I₇/I₈)*R_{reference}.

In FIG. 2 the situation for recording reflectance spectrum 7 is represented, with baffle 8 positioned such that the photodetector 3 only measures light reflected via the wall of the integrating sphere.

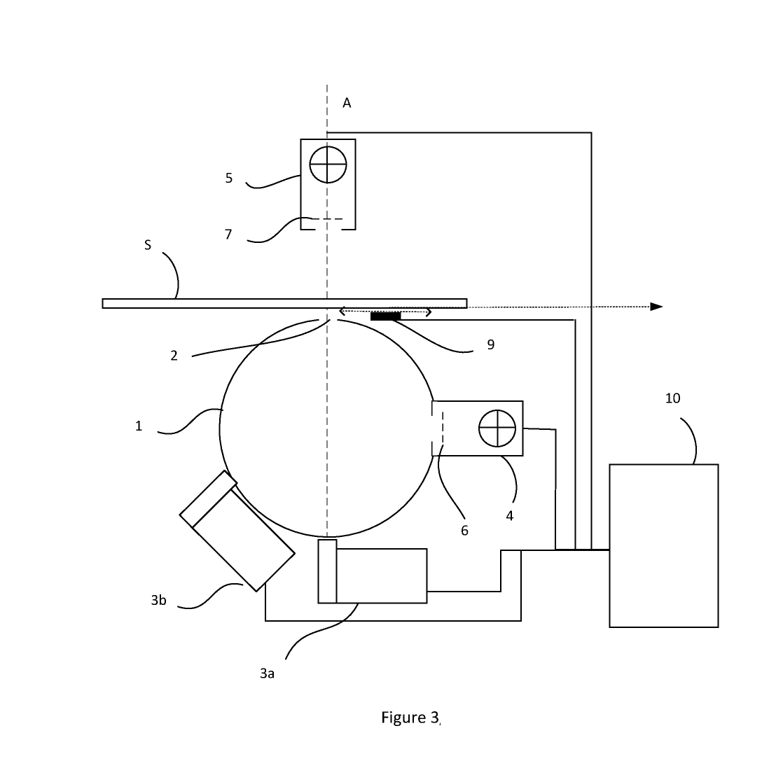

FIG. 3 schematically illustrates an alternative embodiment of the invention, wherein 2 photodetectors and spectrometers 3a (also referred to as axial detector) and 3b are connected to the integrating sphere 1 at detection ports, to measure light reflected from the wall of sphere 1, or coming directly from the sample port 2, respectively. No switching baffle is needed in such embodiment.

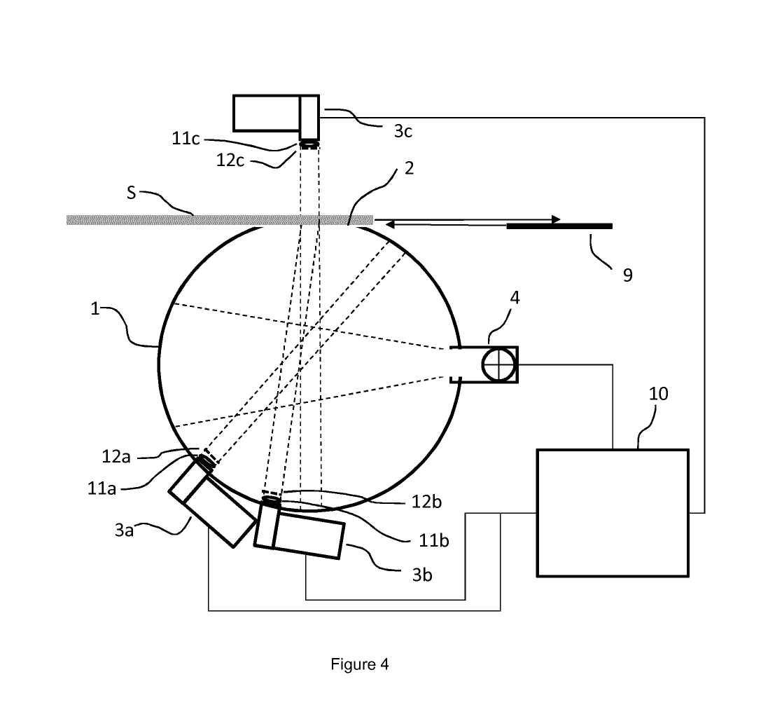

FIG. 4 schematically illustrates an alternative embodiment of the invention, wherein two photodetectors and spectrometers 3a and 3b are connected to the integrating sphere 1 at detection ports. Photodetector 3a is also referred to as wall detector as it measures light reflected from the inner wall of the integrating sphere 1. Photodetector 3b is also referred to as reflectance detector as it measures light coming directly from the sample port 2. Because of the directional sensitivity of the photodetector (preferably enhanced by a collimator) photodetector 3b will therefore measure the light from integrating sphere reflected by the sample when the sample is placed at the sample port. Furthermore, a third photodetector and spectrometer 3c are arranged axially aligned (indicated by line A) with the sample port and opposite to the sample, S. Photodetector 3c is also referred to as transmittance detector as it measures coming from the integrating sphere through the sample or reference standard (if present). No switching baffle is needed in this embodiment. In FIG. 4, the light beam directed from the internal light source is also indicated. It is observed that the light beam from the internal light source does not fall directly on any of the detectors 3a and 3b, on the sample opening or on the part of the wall measured by the wall detector (also indicated in FIG. 4 opposite of wall detector 3a). After the first reflection of the light beam of the internal light source on the wall of the integrating, the light will be distributed to all parts of the wall and again further reflected to create what can be considered a homogenous light source evenly at all parts of the wall. Each of the detectors are preferably connected to a separate collimator 11 and movable shutter 12, which shutter is preferably arranged close to the collimator to allow for as short movement distance between open and closed position as possible. Such collimators and moveable shutters are also preferably arranged for detectors in other embodiments of the invention including the embodiments disclosed in FIGS. 1-3.

In FIG. 4, the detectors 3a and 3b are indicated as being arranged partially inside the integrating sphere. The detectors may also be arranged outside the wall for example connected via a connecting tube.

1. A system for measuring light transmission and/or light reflection properties of a transparent sample sheet, the system comprising a detection assembly and a control unit, wherein the detection assembly comprises
an integrating sphere having
a sample port,
an illumination port;
a detection port;
an internal light source positioned at the illumination port;
a photodetector coupled to a spectrometer and positioned at the detection port; and
means to detect radiation coming either directly from the sample port or from the wall of the integrating sphere or both directly from the sample port and from the wall of the integrating sphere;
an external light source or a transmittance detector axially aligned with the sample port;
means to illuminate either with the internal light source or with the external light source if present or with no light source;
a reference standard, and means to position it at and from the sample port.

2. The system according to claim 1, wherein the integrating sphere has a diameter of about 160 to 300 mm and the sample port has a diameter of about 40 to 60 mm.

3. The system according to claim 1, wherein the internal and external light source each comprise a mechanical shutter as the means to illuminate with the internal light source or with the external light source or with no light source.

4. The system according to claim 1, wherein the integrating sphere contains only one photodetector and one spectrometer.

5. The system according to claim 1, wherein the system comprises the means to detect radiation coming both directly from the sample port and from the wall of the integrating sphere, wherein the means comprises one photodetectors and spectrometers for measuring radiation from the wall of the integrating sphere, and one photodetectors and spectrometers for measuring radiation from the integrating sphere reflected from the sample port;
the system comprises the transmittance detector axially aligned with the sample port and no external light source;
and the photodetectors being capable of during use to measure radiation from the wall, radiation reflected from the sample port and radiation transmitted via the sample port at the same time.

6. The system according to claim 1, wherein the integrating sphere comprises a movable baffle as means to detect radiation coming either directly from the sample port or from the wall of the integrating sphere.

7. The system according to claim 1, wherein each photodetector is provided with a collimator and a movable shutter for preventing radiation from the integrating sphere from reaching the photodetector.

8. The system according to claim 1, wherein the system further comprise a frame having at least two arms, between which arms the sample sheet can be positioned or transported to be measured, with a first arm of said frame carrying the integrating sphere and a second arm carrying the external light source.

9. The system according to claim 1, wherein the reference sample is a silicon wafer.

10. A method for measuring light transmission and/or reflection properties of a transparent sample sheet using the system according to claim 1, the method comprising the steps of
a1) recording a spectrum using the external light source and without any sample at the sample port, a2) recording a spectrum using the external light source and with the sample sheet positioned at the sample port, a3) recording a spectrum using the internal light source and without any sample at the sample port, and a4) recording a spectrum using the internal light source and with the sample sheet positioned at the sample port; and/or the steps of
b1) recording a spectrum of radiation directly reflected from the sample port using the internal light source and with a reference standard at the sample port, b2) recording a spectrum of radiation directly reflected from the sample port using the internal light source and with the sample sheet positioned at the sample port, b3) recording a spectrum of radiation reflected from the wall using the internal light source and without a sample at the sample port, and b4) recording a spectrum of radiation reflected from the wall using the internal light source and with the sample sheet positioned at the sample port; and a step of
c) computing transmittance T and/or reflectance R from these spectra.

11. A method for measuring light transmission and/or reflection properties of a transparent sample sheet using the system according to claim 1, the method comprising the steps of
a1) recording a spectrum using the transmittance detector and the internal light source and without any sample at the sample port, a2) recording a spectrum using the transmittance detector and the internal light source and with the sample sheet positioned at the sample port, a3) recording a spectrum using the photodetector positioned at the detection port and the internal light source and without any sample at the sample port, and a4) recording a spectrum using the photodetector positioned at the detection port and the internal light source and with the sample sheet positioned at the sample port; and the steps of
b1) recording a spectrum of radiation directly reflected from the sample port using the photodetector positioned at the detection port and the internal light source and with a reference standard at the sample port, b2) recording a spectrum of radiation directly reflected from the sample port using the photodetector positioned at the detection port and the internal light source and with the sample sheet positioned at the sample port, b3) recording a spectrum of radiation reflected from the wall using a photodetector and the internal light source and without a sample at the sample port, and b4) recording a spectrum of radiation reflected from the wall using a photodetector and the internal light source and with the sample sheet positioned at the sample port; and a step of
c) computing transmittance T and/or reflectance R from these spectra.

12. The method according to claim 11, wherein the steps a2), a4) and b2) are carried out at the same time, preferably the measurement of steps a2), a4) and b2) is carried out at least 5 times for each sample sheet, more preferably the measurement are carried out at different positions of each sample sheet.

13. The method according to claim 10, wherein the steps a1) and a3) are carried out between sample sheet and the recorded spectra in steps a1) and a3) are used for computing transmittance T and/or reflectance R for multiple measurements of a2), a4) and/or b2).

14. The method according to claim 10, wherein the step b1) is carried out with a frequency of less than once every 10 sample sheets, preferably with a frequency of less than once every 30 sample sheets, more preferably with a frequency of less than once 100 sample sheets.

15. The method according to claim 10, using a system, wherein the shutter is movable between an open position where radiation may enter the photodetector from the integrating sphere and a closed position where the shutter blocks radiation from the integrating sphere, the method further comprising the step of measuring a dark signal from the photodetector with the shutter in the closed position and subtracting the dark signal when computing transmittance T and/or reflectance R, preferably the dark signal is measured at least one time for each photodetector for each sample sheet.

16. The method according to claim 8, wherein measuring is done at multiple positions on the sample sheet, by synchronously moving the integrating sphere and external light source transversely relative to the sample sheet, while maintaining alignment of integrating sphere and external light source, and of detection assembly and sample sheet.

17. A process of making an AR-coated transparent non-continuous sheet is made by steps of
i) applying a liquid AR coating composition to the sheet;
ii) drying and curing the applied coating composition; and
iii) measuring light transmission and/or reflection properties of the coated sheet according to the method of claim 10;
iv) adjusting step i) and/or step ii) based on the results of step iii) to result in a sheet having desired light transmission and/or reflection properties.

18. The process of claim 17 further comprising the step of
a) applying a unique identifier to the sample sheet or reading a unique identifier of the sample sheet; and
b) create a record of the light transmission and/or reflection properties of the coated sheet together with the unique identifier, and optionally add conditions of step i) and/or step ii) in the record.

19. Use of the system according to claim 1 for inline quality assurance in manufacturing of solar modules.
